(19) United States
(12) Patent Application Publication
(10) Pub. No.: US 2004/0160896 A1
(43) Pub. Date: Aug. 19, 2004

(54) Method and apparatus for adaptive capture of voice over packet (VoP) data

(76) Inventors: Steve Luna, Colorado Springs, CO (US); Brad Doerr, Colorado Springs, CO (US); Alistair Kenneth Clement Scott, Colorado Springs, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/366,993

(22) Filed: Feb. 14, 2003

(51) Int. Cl. H04J 1/16; H04L 12/66

(52) U.S. Cl. 370/235; 370/352

(57) ABSTRACT

A method of measuring a voice over packet (VoP) network captures and identifies at least one packet on a network as a VoP signaling packet and determines a call of interest based upon information contained in the signaling packet. The method then captures and identifies at least one additional packet as a VoP data packet, and analyzes the VoP data packet only if the VoP data packet corresponds to the call of interest.

An apparatus for measuring a Voice over packet network comprises a filter engine that accepts packets on a network and identifies each packet as one type of packet as either a VoP signaling packet, a VoP data packet, or some other type of packet. A call signaling analyzer accepts the signaling packets and creates a call flow record for an active call. A trigger analyzer accepts parameters to define a call of interest to the filter engine and a flow engine accepts VoP data packets from the filter engine. A flow application then analyzes the VoP packets.

### BACKGROUND

Organizations around the world want to reduce rising communications costs. The consolidation of separate voice and data networks offers an opportunity for significant savings. Accordingly, the challenge of integrating voice and data networks is becoming a rising priority for many network managers. Organizations are pursuing solutions which will enable them to take advantage of excess capacity on broadband networks for voice and data transmission, as well as utilize the Internet and company Intranets as alternatives to costlier mediums.

In general, circuit based calls are currently of higher quality than packet based. There is an incentive to correct this deficiency by creating networks where the quality of VoP calls is the same or better than circuit based communications. In order to achieve this objective, it is desirable to be able to measure voice quality for calls on a VoP network and to identify those network conditions that cause a VoP call to be of substandard quality. Because multiple calls are transmitted over a VoP network, there is a need to measure voice quality in multiple calls in order to assess the sufficiency of the service for its intended application. Prior art measurement solutions of VoP networks suffer from the difficulty in capturing and measuring all calls simultaneously because current high-bandwidth networks are able to transmit more data than measurement network processors are able to analyze.

A prior art testing method includes an active test where a “test call” is established on a network link and known data is transmitted. This testing method suffers from the requirement that any problem in the network must be reconstructed before it can be diagnosed. Accordingly, there is a need for a passive test method wherein measurements of an operational network may be made by eavesdropping. In low bandwidth networks, it is possible to capture and analyze all calls. There remains a need, however, for passive measurement of a high-bandwidth VoP network.

### SUMMARY

A method of measuring a voice over packet (VoP) network comprises the steps of capturing and identifying at least one packet on a network as a VoP signaling packet and determining a call of interest based upon information contained in at least one signaling packet. The method continues with the steps of capturing and identifying at least one additional packet as a VoP data packet, and analyzing the VoP data packet only if the VoP data packet corresponds to the call of interest.

According to another aspect of an embodiment of a method for measuring voice quality on a voice over packet network comprises the steps of accepting a data packet corresponding to a call and comparing a descriptor of the data packet against a trigger condition. If the trigger condition exists for the data packet, the method further comprises the steps of aggregating the data packet into a flow information record, calculating statistics from the aggregated flow information record, and storing the statistics.

An apparatus for measuring a Voice over packet network comprises a filter engine that accepts packets on a network and identifies each packet as one type of packet in a group consisting of a VoP signaling packet, a VoP data packet, and other packets. The apparatus further comprises a call signaling analyzer that accepts the signaling packets and creates a call flow record for an active call. A trigger analyzer accepts parameters to define a call of interest to the filter engine and a flow engine accepts VoP data packets from the filter engine. The apparatus further comprises a flow application that analyzes the VoP packets.

A method for measuring a voice over packet network comprising the steps of establishing triggers that define characteristics of one or more calls of interest and capturing data packets for the one or more calls of interest. The method continues by aggregating information based upon the data packets, calculating statistics based upon the aggregated information-, and storing the statistics

Advantageously, certain embodiments of a test system according to the present teachings permit real-time analysis of high bandwidth voice over packet networks.

### BRIEF DESCRIPTION OF THE DRAWINGS

FIG. 1 is a simplified block diagram of an illustrative network with voice over packet data.

FIG. 2 is a block diagram of an embodiment of a measurement system according to the teachings of the present invention.

FIG. 3 is a data flow diagram of an embodiment of a method according to the teachings of the present invention.

FIG. 4 is a flow chart of an embodiment of a filter engine according to the teachings of the present invention.

FIG. 5 is a flow chart of an embodiment of a call signaling analyzer according to the teachings of the present invention.

FIG. 6 is a flow chart of an embodiment of call flow record logic according to the teachings of the present invention.

FIG. 7 is a flow chart of an embodiment of a flow engine according to the teachings of the present invention.

FIG. 8 is a data flow diagram of an alternate embodiment of a system according to the present teachings.

### DETAILED DESCRIPTION

A passive test of a high bandwidth VoP network comprises a method wherein only a subset of all VoP calls on a network are analyzed in order to assess the sufficiency of a VoP link. The subset of VoP calls are termed the “calls of interest” and are isolated from all other calls and data transmitted on the network. Examples of calls of interest that are isolated from the other calls on the network include, but are not limited to calls that contain errors or an abnormal disconnect, calls that use a specific coder/decoder, calls that use a specific path, router or media, calls that originate or terminate at a specific endpoint or caller, calls that implement conference calls, and calls using a long distance service.

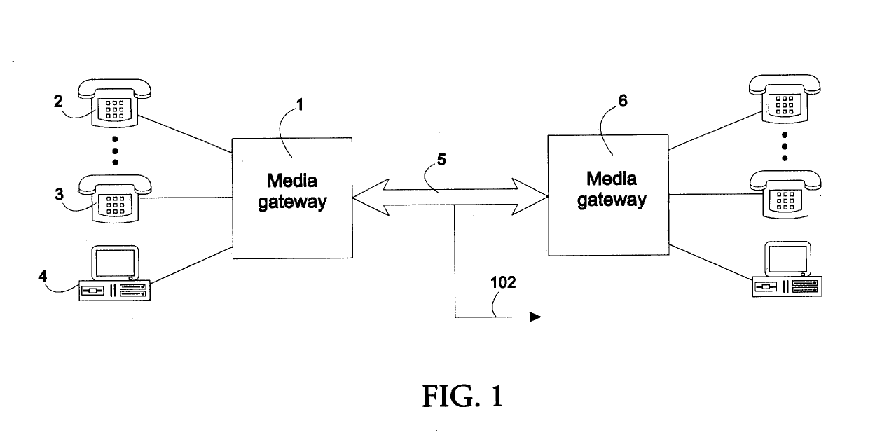

With specific reference to FIG. 1 of the drawings, there is shown a simplified block diagram of an illustrative VoP network wherein a first media gateway 1 accepts conversation traffic from one or more telephones 2, 3 and perhaps one or more electronic devices such as a computer 4. The first media gateway accepts the conversation traffic and encodes each conversation into a VoP call using one or more signaling and data VoP protocol packets. The encoded packets of all of the calls and data are launched onto a VoP network 5. In the specific embodiment shown, the VoP network 5 is a 100 BaseT Ethernet network link. An opposite side of the VoP network 5 has a second media gateway 6 that receives the encoded packets and routes them to their respective destinations.

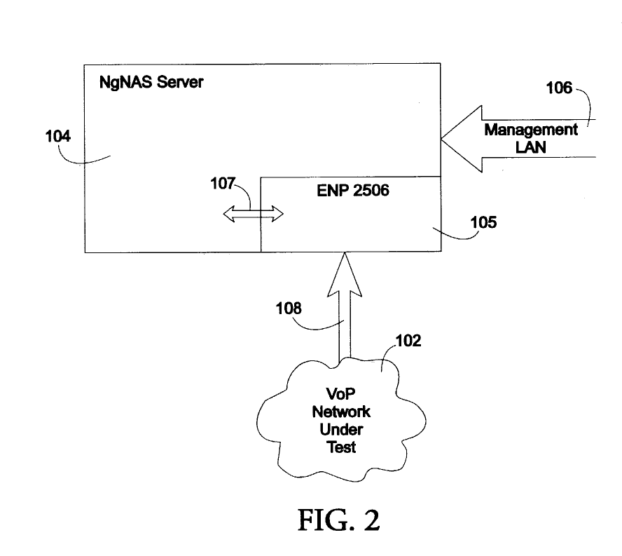

With specific reference to FIG. 2 of the drawings, there is shown a block diagram of a hardware system for implementation of the present teachings in which a a network under test 102 may carry VoP calls for analysis by the illustrated system. The calls may be encoded with any number of VoP protocols including without limitation H.323, media gateway control protocol (MGCP), and session initiation protocol (SIP). A workstation 104, which in a preferred embodiment is a Sun Netra-20 running a Solaris operating system and Agilent Technologies NgN software, is populated with a network card 105, which in a preferred embodiment is an ENP2506 plug-in network card 105 by Radisys, Corp. The ENP2506 includes an IXP1200 processor with six microprocessor engines. It runs a VXWorks operating system by Windriver and a Tornado development environment. Four of the microprocessor engines in the network card 105 are used for a filter engine process and two are used for a flow engine process. As one of ordinary skill in the art will appreciate with benefit of the present teachings, the assignment of microprocessor engine to a particular process is for the primary purpose of load balancing and processing efficiency and may vary depending upon a specific implementation of the present teachings. The network card 105 passively monitors data traffic carried by the network under test 102 over the test network connection 108. The workstation 104 communicates with the network card 105 through a conventional PCI bus 107 and communicates with other devices using a management LAN 106. External communication over the management LAN 106 is for purposes including without limitation receiving requests from external devices and reporting collected and calculated data to external devices.

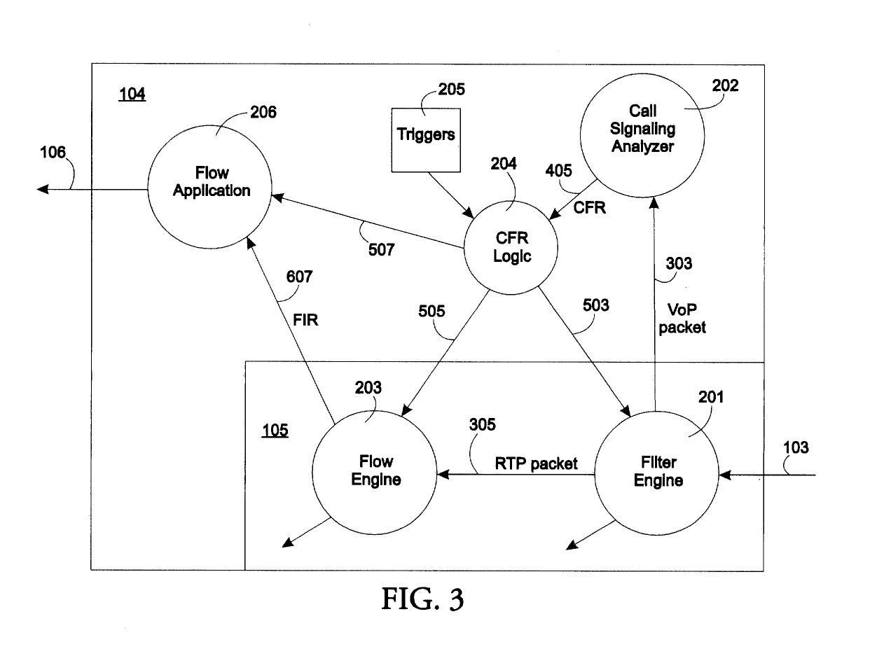

With specific reference to FIG. 3 of the drawings, there is shown a data flow diagram of an embodiment of a method according to the present teachings in which network data on the test link 103 is received by a filter engine 201. The filter engine 201 is a software process running on four of the microprocessor engines that are on the network card 105.

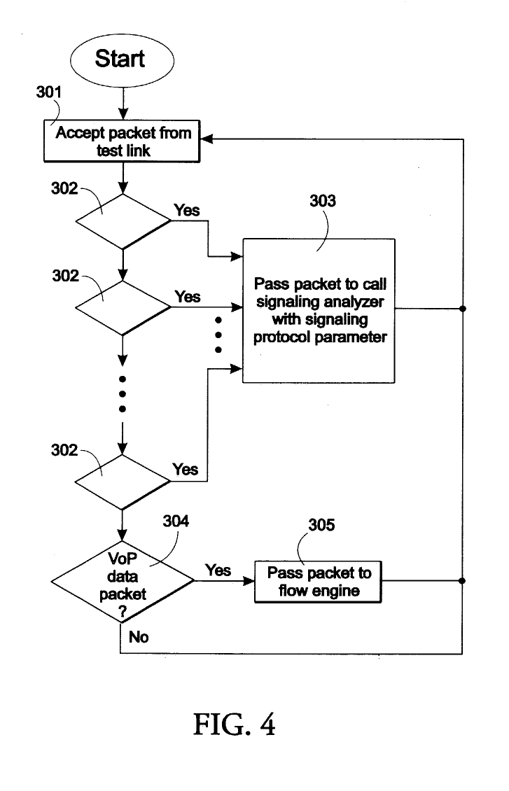

With specific reference to FIG. 4 of the drawings, there is shown a flow chart of the filter engine process 201. The filter engine 201 accepts 301 and captures a data packet from the active test link 103. The data packet is either a VoP signaling packet, a VoP data packet, or some other kind of packet. The filter engine 201 determines through a series of comparisons 302 against known protocols if the data packet is a VoP signal packet and if so, what type of signal protocol is used. If one of the series of comparisons 302 yields a match to one of the supported signaling protocols, the filter engine 201 passes 303 the VoP signaling packet and the protocol type information to a call signaling analyzer 202 and begins the filter engine process for the next consecutive packet on the test link 103. If the packet is not identified as a VoP signaling packet, the filter engine 201 attempts to identify 304 it as a VoP data packet. A VoP data packets follow a real time protocol and are conventionally termed an “RTP packet”. An RTP packet has header information that includes a timestamp from the sending media gateway, a packet sequence number, an IP address and a port number. The IP address and port number uniquely identify the call to which the RTP packet corresponds. If the filter engine identifies the packet as an RTP packet, it forwards 305 the packet to the flow engine 203 and begins the filter engine process for the next consecutive packet on the test link 103. If the packet is neither a VoP signaling packet nor an RTP packet, then the filter engine discards the packet without further processing. The filter engine process then returns to the beginning to accept and process the next consecutive data packet.

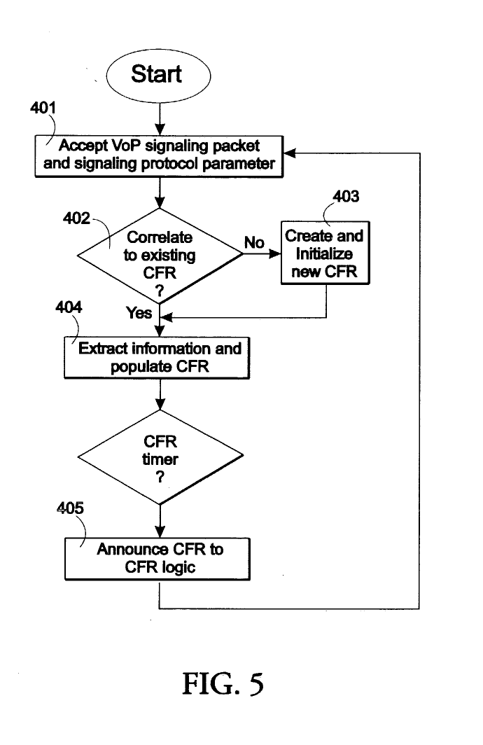

With specific reference to FIG. 5 of the drawings, there is shown a flow chart illustrating the call signaling analyzer 202. The call signaling analyzer is the NgN software product available from Agilent Technologies, Inc. Technology contained in the call signaling analyzer 202 is disclosed is European patent application published Oct. 16, 2002 with publication no. 1249986 and European patent application published Apr. 18, 2001 with publication no. 1093312, the teachings of which are hereby incorporated by reference. The filter engine forwards a stream of VoP signaling packets from the call signaling analyzer at 303. With each VoP packet in the stream, the filter engine 201 also receives a signaling protocol parameter that indicates the specific signaling protocol used in the VoP signaling packet. The call signaling analyzer 202 accepts the VoP signaling packet and signaling protocol parameter at 401. The call signaling analyzer 202 determines 402 if a call flow record (CFR) already exists for the call represented by the VoP signaling packet. If the call is new and a CFR does not already exist, the call signaling analyzer establishes 403 a new CFR. The call signaling analyzer then extracts 404 information from the VoP signaling packet and populates the CFR with the extracted information. Multiple VoP signaling packets are used to fully populate the CFR. There is one unique CFR per call on the link. The CFR is a data structure that stores information for the call including:

Call Create Time: The time that the first message was received.

Calling Number: The phone number that originated the call.

Call ID: Identifier assigned by the soft switch to the call.

Call State: Connected, disconnected, or in progress.

Dialed Number: The phone number that was called.

IP Addresses: IP addresses of all elements involved in call (e.g. soft switch, media gateway, etc).

Protocols: Signalling protocols used in call.

Running Time: The duration the call has been running if the call is still in progress.

Status: OK, error, maintenance, or warning.

RTP Path Info: IP address and UDP ports of RTP stream

Answered: Whether or not the called party answered the call.

Bearer Capability: Specifies a requested service: packet or circuit mode, data rate, type of information content.

Blocked: Any message that affects the blocking condition of a circuit or a group of circuits will be indicated. Circuits may be blocked, unblocked or reset at any time, and one or more calls may be released as a result. If a value is blank, it means that no blocking or unblocking messages were included with this call record.

CIC: CIC of the IAM portion of the call segment.

COTFailed: If a continuity test was requested on the circuit before the call was placed this field will list any protocols, which indicated a continuity test failure.

COTRequested: This field will list any protocols that issued a request for a continuity test on the circuit before the call was placed.

COTSuccessful: If a continuity test was requested on the circuit before the call was placed, this field will list any protocols, which indicated a continuity test succeeded.

Call Answer Time Window: The time at which the call was answered. If the field is blank, then the call was not answered. Display in SMR tab: HH:MM:SS:mmm

Call Create Time: The time at which the call started.

Call Duration: The duration (from connection completed to connection released) of the call.

Call Setup Time: Time to set up the call, from IAM to ANM (SS7 only). HH:MM:SS:mmm

Call Teardown Time: Time to disconnect the call, from REL to RLC (SS7 only). Display format: HH:MM:SS:mmm

Carrier ID Code: A three or four digit number, which uniquely identifies the carrier through which the call was routed (SS7 only).

Dial Tone Delay: Time from off-hook to dial tone received. Display format: HH:MM:SS:mmm

DPC: Destination Point Code found in the IAM portion of the SS7 protocol.

GAP: The Generic Address Parameter GAP field from the IAM message (SS7 only). If blank, the IAM message was not seen or did not contain a GAP parameter.

JIP: The six digit Jurisdiction Information Parameter JIP field from the IAM message. (SS7 only). If blank, the IAM message was not seen, or did not contain a JIP parameter.

Local PC (Point Code): Point code of the local switch or device handling the call (SS7 only). If blank, it means that the IAM message was not seen.

LRN: The 10-digit Local Routing Number field from the IAM message (SS7 only). If blank, the IAM message was not seen or did not contain a LRN parameter because Local Number Portability was not used.

Maintenance Messages: Displays Maintenance Messages, for example GRS, GRA, and so on.

Originating Answer Delay: The time it took for the originating call to be answered. HH:MM:SS:mmm

Originating Call Processor: The name or IP address of the Call Agent, Call Processor, Media Gateway, Proxy Server or Softswitch that handles the call on the originating side. Could be blank if only the terminating side of the call was visible to the NgNAS, or if the call went directly from endpoint to endpoint without going through a switch.

Originating Endpoint: The name or IP address of the Subscriber Gateway, SIP Entity, or H.323 Terminal that originated the call. Could be blank if only the terminating side of the call was visible to the NgNAS.

Originating Endpoint Type: The type of device that originated the call.

OPC: Originating Point Code found in the IAM of the SS7 protocol.

Originating Release Delay: The time it took for the originating device to completely release the call and become available for another call. Display format: HH:MM:SS:mmm

Originating RTPjitter: The RTP jitter reported by the originating side of the call. (MGCP only). HH:MM:SS:mmm

Originating RTPlatency: The RTP latency reported by the originating side of the call (MGCP only). HH:MM:SS:mmm

Originating Packets Rx: The RTP packets received by the originating side of the call (MGCP only).

Originating Packets Tx: The RTP packets sent by the originating side of the call (MGCP only).

Originating Packets Lost: The RTP packets lost as reported by the originating side of the call (MGCP only).

Post Dial Delay: The time between when the call originator finished dialing and when the switch indicated that the call was in progress. HH:MM:SS:mmm

Release Time: Not to be confused with Release Time for CFRs. Timestamp of the last call segment (primitive) that ends the call. Failed calls will not display a Release Time.

Rel Cause Code: The reason that the call disconnected.

Release Code: For Release Code interpretation, refer to SS7/IPDC Cause Values or MGCP Response Detail.

Remote PC (Point Code): Point code of the remote end of the call. (SS7 only). If blank, it means that the IAM message was not seen.

Softswitch Address: The IP address or DNS name of the softswitch that sets up the call. This is obtained from the IP source address field of the RCSI message.

Start Time: Not to be confused with Call Create Time for CFRs. Timestamp of the first call segment (primitive) that starts the call.

Term Answer Delay: The time it took for the call to be answered ( from the terminating call's perspective). HH:MM:SS:mmm

Term Call Processor: The name or IP address of the Call Agent, Call Processor, Media Gateway, Proxy Server or Softswitch that handles the call on the terminating side. Could be blank if only the originating side of the call was visible to the NgN application, or if the call went directly from endpoint to endpoint without going through a switch.

Term Direction: Who terminated the call: Subscriber or Network. If blank, the call never connected, or never disconnected.

Term Endpoint: The name or IP address of the Subscriber Gateway, SIP Entity, or H.323. terminal that originated the call. Could be blank if only the originating side of the call was visible to the NgNAS.

Term Endpoint Type: The type of device that terminated the call.

Term RTP jitter: The RTP jitter reported by the terminating side of the call (MGCP only). HH:MM:SS:mmm

Term RTP latency: The RTP latency reported by the terminating side of the call (MGCP only). HH:MM:SS:mmm

Term Packets Rx: The RTP packets received by the terminating side of the call (MGCP only).

Term Packets Tx: The RTP packets sent by the terminating side of the call (MGCP only).

Term Packets Lost: The RTP packets lost as reported by the terminating side of the call (MGCP only).

Time To Answer: Time between the IAM and ANM messages. Basically, the time it took for the call to be answered. If the call was not answered (no ANM was received) the field will be blank.

Trunking Gateway Address: The IP address or DNS name of the trunking gateway that carries the call. This is obtained from the IP destination address field of the RCSI message.

Term Release Delay: The time it took for the terminating device to completely release the call and become ready for another call. HH:MM:SS:mmm

The overall function of the call signaling analyzer according to the teachings of the present invention, therefore, is to collect and correlate related VOP signaling packets and to extract information from the VoP signaling packets necessary to populate the CFR data structure for purposes of call test administration. When a CFR indicates that the current call has been fully setup or if some period of time has lapsed since the last VoP signaling packet for the current CFR, the call signaling analyzer announces 405 the CFR to CFR logic 204. Accordingly, even if the current call was not completely set-up, the system attempts to capture packets for the call because the failure to set-up may be important data in diagnosing a reported problem. The CFRs are held in memory for some pre-determined period of time. In a specific embodiment, the pre-determined period of time is 30-90 days. Advantageously, access to the CFRs permits later retrieval of measurement data relating to a specific call. This can be important when a call is reported as sub-standard. A service provider using a system according to the teachings of the present invention can receive a complaint and retrieve data on the reported call to ease diagnosis and correction of the problem.

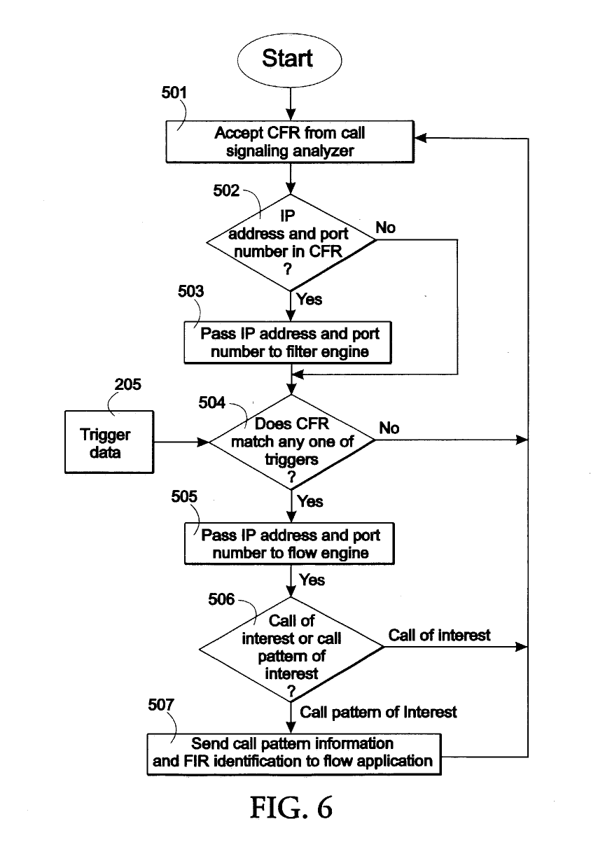

With specific reference to FIG. 6 of the drawings, there is shown a flow chart illustrating the CFR logic process 204. The CFR logic process 204 accepts 501 the CFR from the call signaling analyzer 202 when the CFR is announced 405. The CFR logic determines 502 if the announced CFR contains an IP address and port number of the call. If so, the CFR logic passes 503 the IP address and port number to the filter engine 201. If the CFR does not contain the IP address and port number, the CFR logic process continues with the step of determining 504 if information contained in the CFR matches any one of a number of triggers 205. The triggers are conditions or boolean combinations of conditions that define a call of interest. It is the calls of interest that are ultimately captured and analyzed, while other calls and data packets are discarded. A trigger may be defined for any data field captured by the CFR. As a practical matter, it is believed that some of the more useful triggers are a specific phone number, a route that includes a specific media gateway, signaling gateway, gatekeeper and router, a specific codec, a call that contains a disconnect prior to call termination, a call that contains errors, conference calls and calls of either unusually short or unusually long duration. A trigger may also include a boolean combination of any of the data captured in the CFR. Triggers permit adaptive analysis of only certain calls that assists in the isolation of a problem in a specific piece of equipment or in a specific area of call functionality. Assistance in the isolation of a reported problem advantageously permits a faster resolution of the identified cause of the reported problem. An alternative type of trigger identifies call patterns of interest. As an example, the CFR logic 204 may be configured to identify an event defined by a combination of calls, such as when there is an initiation and termination of a short first call between two phone numbers and then an initiation of a second call between the same two phone numbers a short time thereafter Such a call pattern may be an indication of poor voice quality on the first call. The second call in the pattern, therefore, would be a call of interest. The CFR logic 204 identifies the call pattern as defined by the triggers 205 and signals the call pattern 507 directly to the flow application 206. The call pattern signaling from the CFR logic 204 to the flow application 206 provides the flow application 206 with information that identifies the FIR 607 relating to the call is a call of interest based upon a call pattern.

As an example of a call of interest trigger, if a certain piece of equipment were new to a network, such as a codec, a trigger that analyzes only those calls that are processed through the codec assists the user of the new equipment in verifying the functionality of it upon installation. The trigger in this case would be all calls having a specific payload type. As another example, a customer may have reported frequent problems in service for conference calls only. Triggering on only conference calls to or from a specific phone number permits analysis of just the reported problem to verify that the problem actually exists and then identifies the magnitude of the problem. Additionally, a user may modify the triggers to methodically isolate a call problem.

In a specific embodiment, the triggers are stored in a trigger data file comprising string data separated by semi-colons. The CFR Logic 204 reads the trigger data file. The data trigger file includes an identification of the trigger category, an equals sign, and then the trigger itself. Boolean combinations use the ‘and’ and ‘or’ terminology as well as mathematical ‘greater than’, ‘less than’ and parentheses conventions for more complicated triggers. For illustrative purposes, a single trigger data file may include the following:

calling_num=4155554455;

dialed_num=4155551921;

ip=130.29.44.165 and pay_load_type=18;

call_state=disconnected and call_status=error;

(ip=130.29.44.165 or ip=130.29.44.166 or ip=130.29.44.167) and (call_status=error);

(call_duration>1:00:00) or (call_duration<0:00:01);

Each line that is separated by a semi-colon is a different trigger. Accordingly, all calls that satisfy any one of the triggers are calls of interest. If a customer complained of voice quality, the first two triggers of calling_num and dialed_num permits analysis of only VoP calls to or from that phone number. The third trigger identifies a particular codec on the network. Analysis of calls from one codec allows monitoring a new piece of equipment to assure that its use does not adversely affect voice quality. It is common to capture all calls with identified errors because the error status indicates a problem and collection and analysis of all calls with errors helps to isolate a source of the errors. A user might see that most errors occur when the call passes through one or more media gateways. The user may then modify the trigger to capture all calls with errors that also include the IP address of the media gateway in question. An example of such a trigger is the fourth trigger in the sample triggers. It is also beneficial to analyze calls of both very short duration and very long duration. Long duration calls are interesting because they contain a lot of data and are prone to errors. Short duration calls are interesting because they can possibly signify a voluntary call termination by the caller or callee as a result of poor voice quality. A user can modify the triggers by accessing and modifying the trigger data file. Alternatively, the user may enter the triggers using a graphical user interface (GUI).

If the CFR matches any of the user defined triggers 205 or the CFR logic 204 identifies a call of interest based upon a call pattern trigger, the CFR logic 204 passes 505 the IP address and port number of the call to the Flow engine 203. As one of ordinary skill in the art appreciates from review of FIG. 6, the IP address and port number is possibly sent twice in the CFR logic process. In the first instance, the IP address and port number of any VoP call is sent to the filter engine 201. Accordingly, the filter engine 201 captures and forwards to the flow engine 203 all RTP packets. In the second instance, the IP address and the port number of only the VoP calls that match the defined trigger criteria are sent to the flow engine 203. Accordingly, the flow engine 203 processes only those VoP packets that correspond to the calls of interest. The CFR logic 204 then determines if the call of interest is based upon a call of interest trigger or is based upon a call pattern trigger 506. If the call is based upon a call of interest trigger, no further processing is necessary and the process continues from the beginning. If the call is triggered for capture based upon a call pattern of interest, the CFR logic 204 also sends the call pattern information together with the respective FIR to the flow application 206. In this way, the flow application can identify the call as being part of a call pattern having poor voice quality.

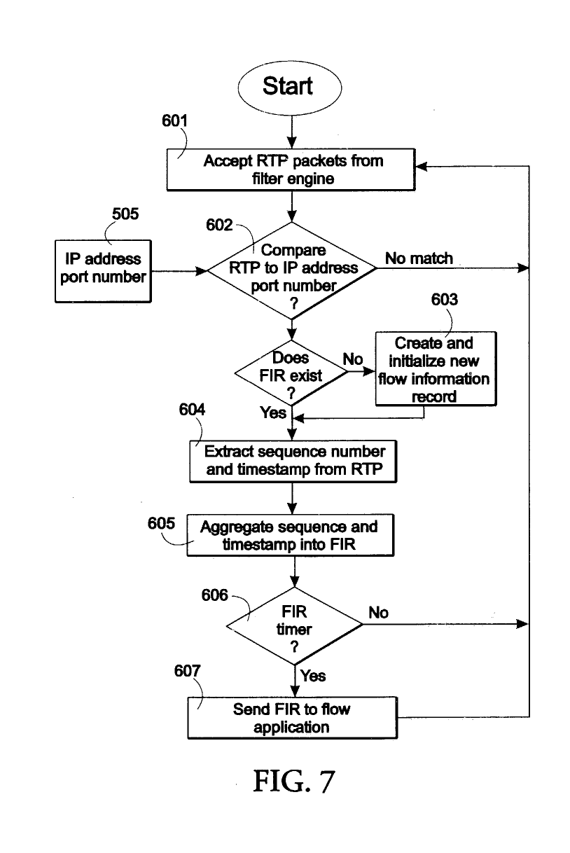

With specific reference to FIG. 7 of the drawings, there is shown a flow chart of the flow engine 203. The flow engine 203 accepts 601 RTP packets from the filter engine 201. The flow engine 203 compares 602 the RTP information to the IP address and port number sent 505 by the CFR logic 204. If the RTP does not match any of the triggers 205 the flow engine 203 does not further process the RTP packet and returns to the beginning of the process to accept the next consecutive RTP packet. If the RTP packet matches the IP address and port number, the flow engine determines whether a flow information record (FIR) exists for the current call. If the FIR does not exist, the flow engine 203 creates and initializes a new FIR and continues. The flow engine 203 then extracts 604 a sequence number and timestamp from the RTP. The sequence number and timestamp is then aggregated 605 into the FIR for the current call. After a predetermined period of time 606, the flow engine 203 sends 607 all active FIRs to the flow application.

The flow application 206 is software that calculates statistics on the aggregated FIRs sent to it by the flow engine. Calculations include, but are not limited to measurements of packet loss, jitter, silence detection, and predictive mean opinion score. The flow application performs all calculations and stores periodic results in a database on a per-call basis. Calculations made by the flow application 206 are accessed by devices via the management LAN 106 for display to a user or for use by other applications such as Agilent Technologies, Inc. Firehunter product to summarize the data over multiple calls.

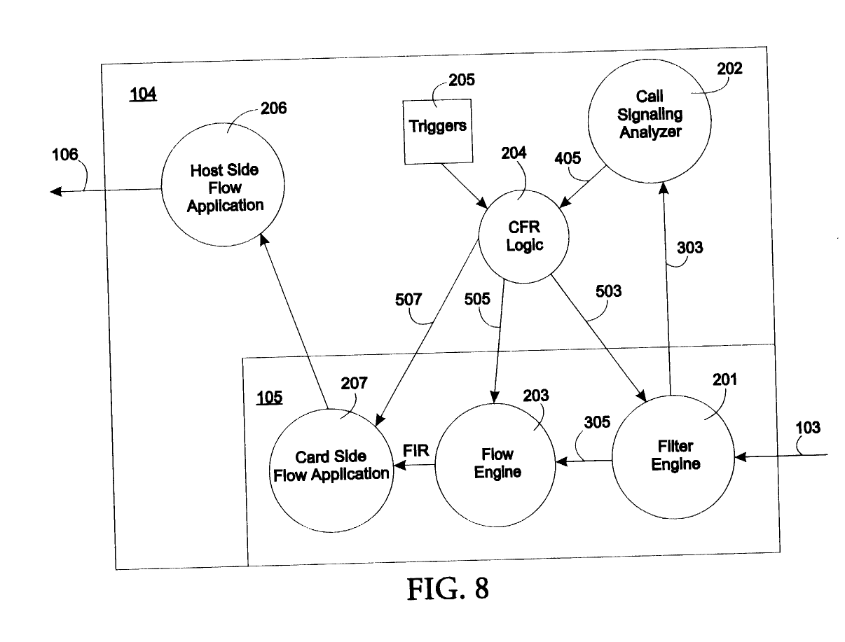

With specific reference to FIG. 8 of the drawings, there is shown a data flow diagram of an alternate embodiment according to the teachings of the present invention. Referring to FIG. 3 of the drawings, there is shown a flow application 206 on only a host side of the processor hardware. Referring to FIG. 8 of the drawings, there is shown both a host side flow application 206 as well as a card side flow application 207. The embodiment of FIG. 8 of the drawings is useful if additional processing power were needed to make calculations on the FIRs or if it were beneficial to off-load processing responsibilities from the host workstation 104 to the processors on the network card 105.

In an embodiment according to the teachings of the present invention, it is also possible to identify and analyze patterns of the calls of interest. Each call of interest has one or more call characteristics that are captured by the data in the CFR. As an example, calling phone number, called phone number, call duration, and network route. The call pattern analysis categorizes and aggregates calls of interest based upon the call characteristics. Call patterns become apparent as a result of the aggregation. This analysis is performed efficiently in the CFR Logic 204 and results are signaled to the flow application 206. Alternatively, call combinations may also be captured. As an example, combinations of call conditions between the same two phone numbers or common network routes is a potential indicator of poor voice quality. Specifically, if a call is terminated and then rapidly re-established in either call direction, it may indicate a connection and termination due to poor voice quality and then rapid re-establishment to complete the call. The captured pattern, therefore, is one or more short duration calls followed quickly by a longer call between the same two phone numbers.

Embodiments of the invention are described herein by way of example and are intended to be illustrative and not exclusive of all possible embodiments that will occur to one of ordinary skill in the art with benefit of the present teachings.

1. A method of measuring a voice over packet (VoP) network comprising the steps of:
capturing and identifying at least one packet on a network as a VoP signaling packet,
determining a call of interest based upon information contained in said at least one signaling packet,
capturing and identifying at least one additional packet as a VoP data packet, and
analyzing said VoP data packet only if said VoP data packet corresponds to said call of interest.

2. A method of measuring as recited in claim 1 and further comprising the step of aggregating a plurality of said VoP signal packets to define one or more active calls.

3. A method of measuring as recited in claim 2 and further comprising the step of creating a flow information record for each one of said one or more calls of interest.

4. A method of measuring as recited in claim 3 wherein flow information record is maintained over a predefined length of time after said call of interest is terminated.

5. A method of measuring as recited in claim 3 and further comprising the step of aggregating a plurality of said VoP data packets corresponding to one of said calls of interest.

6. A method of measuring as recited in claim 5 and further comprising said step of populating a flow information record corresponding to one of said calls of interest.

7. A method of measuring as recited in claim 6 wherein said step of analyzing comprises calculating statistics from information contained in said flow information record.

8. A method of measuring as recited in claim 1 and further comprising accepting parameters to define one or more calls of interest.

9. A method of measuring as recited in claim 8 and further comprising the step of aggregating a plurality of said VoP signal packets and comparing information in said aggregated VoP signal packets against said parameters to define one or more active calls of interest.

10. A method of measuring as recited in claim 9 and further comprising the step of aggregating said VoP data packets that correspond to said one or more active calls of interest into one or more flow information records, each flow information record corresponding to one of said one or more active calls of interest.

11. A method of measuring as recited in claim 1 and further comprising the step of calculating statistics based upon said analyzed VoP data packet.

12. A method of measuring as recited in claim 1 wherein said step of analyzing said VoP data packet further comprises the steps of aggregating a plurality of said VoP data packets that correspond to an active call into a flow information record and calculating statistics for said active call based upon information in said flow information record.

13. A method of measuring as recited in claim 1 and further comprising the step of capturing and identifying said at least one packet as neither a VoP signaling packet nor a VoP data packet, and discarding said at least one packet.

14. A method of measuring as recited in claim 1 and further comprising the step of accepting an internet protocol address and port number corresponding to said call of interest and wherein said step of identifying said call of interest comprises comparing an internet protocol address and port number of said VoP data packet to said internet protocol address and port number of said data packet.

15. A method of measuring as recited in claim 1 wherein said VoP data packets comprise RTP packets.

16. A method for measuring voice quality on a voice over packet network comprising the steps of:
accepting a data packet corresponding to a call,
comparing a descriptor of said data packet against a trigger condition, and if said trigger condition exists for said data packet, aggregating said data packet into a flow information record,
calculating statistics for said aggregated flow information record, and
presenting said statistics.

17. A method for measuring as recited in claim 16 and further comprising the steps of repeating said steps of accepting, comparing, aggregating, and calculating for a plurality of data packets.

18. A method for measuring as recited in claim 16 and further comprising the steps of accepting a signaling packet, generating a call flow record, and generating said flow information record.

19. A method for measuring as recited in claim 16 wherein said step of calculating statistics further comprises measuring packet loss and jitter for said aggregated flow information record.

20. An apparatus for measuring a Voice over packet network comprising:
a filter engine that accepts packets on a network and identifies each said packet as one type of packet in a group consisting of a VoP signaling packet, a VoP data packet, and other packets,
a call signaling analyzer that accepts said VoP signaling packets and creates a call flow record for an active call,
a trigger analyzer that accepts parameters to define a call of interest to said filter engine,
a flow engine that accepts said VoP data packets from said filter engine, and
a flow application communicating with said flow engine and further processing data based upon said VoP data packets.

21. An apparatus for measuring as recited in claim 20 wherein said filter engine sends said VoP signaling packets to said call signaling analyzer, sends said VoP data packet to said flow engine and discards said other packets.

22. An apparatus for measuring as recited in claim 20 wherein said flow engine creates a flow information record based upon said VoP data packets and said flow application receives said flow information record.

23. An apparatus for measuring as recited in claim 22 wherein said flow application calculates packet loss and jitter.

24. An apparatus for measuring as recited in claim 20 wherein said flow application calculates packet loss and jitter.

25. A method for measuring a voice over packet network comprising the steps of:
establishing triggers that define characteristics of one or more calls of interest,
capturing data packets for said one or more calls of interest,
aggregating information based upon said data packets,
calculating statistics based upon said aggregated information,
storing said statistics.

26. A method for measuring as recited in claim 25 wherein said triggers comprise call characteristics selected from the group consisting of calling phone number, dialed phone number, route, codec, error status, and call duration.

27. A method for measuring as recited in claim 25 and further comprising the step of modifying said triggers.

28. A method for measuring as recited in claim 25 wherein said step of establishing triggers further comprises presenting a graphical user interface to for entry of said triggers.

29. A method for measuring as recited in claim 25 and further comprising the steps of assessing characteristics of said calls of interest and calculating statistics based upon said characteristics.

30. A method for measuring as recited in claim 25 and further comprising the steps of capturing combinations of calls and assessing call patterns from said calls of interest.
